(19) United States
(12) Patent Application Publication
(10) Pub. No.: US 2009/0010698 A1
(43) Pub. Date: Jan. 8, 2009

(54) TRANSFER APPARATUS AND IMAGE FORMING APPARATUS EQUIPPED THEREWITH

(76) Inventors: Masami MARUKO, Tokyo (JP); Masakazu Nakamura, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/945,972

(22) Filed: Nov. 27, 2007

(30) Foreign Application Priority Data
Jul. 5, 2007 (JP) JP2007-177145

(51) Int. Cl. G03G 15/00

(52) U.S. Cl. 399/406

(57) ABSTRACT

A transfer apparatus for transferring a toner image onto a sheet having: an endless belt; a plurality of rollers for supporting the endless belt around the plurality of rollers; and a discharge section for corona discharging the sheet, wherein the plurality of rollers includes a transfer roller for forming a transfer nip used to transfer the toner image onto the sheet and a separation roller for separating the sheet from the endless belt, and the transfer roller and the separation roller are straight shaped rollers each having a substantially uniform diameter along the longitudinal direction; and wherein at least one of the plurality of rollers other than the transfer roller and the separation roller is formed into a crown shape in which an axially central portion thereof is larger in outer diameter than both end portions thereof.

### RELATED APPLICATION

This application is based on Japanese Patent Application No. 2007-177145 filed with Japanese Patent Office on Jul. 5, 2007, the entire content of which is hereby incorporated by reference.

### BACKGROUND OF THE INVENTION

The present invention relates to a transfer apparatus for transferring a toner image onto a sheet using a belt and an image forming apparatus equipped with the same.

In an image forming apparatus using electrophotographic process, a transfer apparatus using a transfer belt is utilised as the transfer apparatus for transferring a toner image onto a sheet. In the transfer apparatus using a transfer belt, the sheet is conveyed as it is electrostatically adsorbed onto the transfer belt, and therefore, it allows relatively easy separation immediately after transfer, as compared to the transfer apparatus based on a corona discharge method or on a transfer roller. Further, a wider transfer region formed by a photoreceptor and transfer belt can be provided. This ensures an advantage of stable transfer. For these reasons, this arrangement has been preferably employed, despite its complicated structure.

However, in the transfer apparatus using a transfer belt, unstable traveling may result from meandering or other phenomena when the transfer belt is rotated. Unstable traveling causes the transfer belt to be disconnected from the roller aroud which the belt is supported. This may result in lack of stability in the position of the image formed on the sheet. To avoid such unstable traveling, the Japanese Unexamined Patent Application Publication No. S63-221345 and Japanese Unexamined Patent Application Publication No. H10-20716 disclose the technique wherein, when a belt is supported by a plurality of rollers, the rollers are shaped in a crown or inverted crown, whereby stable traveling of the belt is ensured.

However, when a belt is used as a transfer belt, stable traveling as well as transfer performance at the time of transfer as the transfer separation function thereof and separation performance at the time of separation must be ensured uniformly in the longitudinal direction, namely, over the entire sheet surface.

In the Japanese Unexamined Patent Application Publication No. S63-221345 and Japanese Unexamined Patent Application Publication No. H10-20716, no consideration must be given to uniformity at the time of transfer and separation. To be more specific, in relation to the transfer roller and separation roller, nothing is mentioned with respect to selection of a straight shaped roller and a crown or inverted crown shaped roller.

Especially in an image forming apparatus used in the POD market, there is an intense demand for higher speed. In an image forming apparatus designed to meet high speed requirements, separation performance cannot be ensured by curvature separation alone, when a sheet is separated from the transfer belt, and therefore, discharge and separation are carried out using a corona discharge electrode. In this case, if a crown shaped or inverted crown shaped roller is used as a separation roller, uniform discharging cannot foe achieved due to the shape., and sufficient separation performance cannot foe achieved due to uneven discharging. Further, when the sheet is removed from the transfer belt, a garbled character occurs locally.

Similarly, in the transfer region, if a crown shaped or inverted crown, shaped roller is used as a transfer roller, the transfer nip (transfer region) formed between the transfer roller and photoreceptor or other image carrier becomes uneven in the longitudinal direction. Thus, uniform transfer performance cannot be obtained.

The object of the present invention is to solve the aforementioned problems and to provide a transfer apparatus using a transfer belt capable of ensuring the transfer and separation performance as well as the traveling stability of the transfer belt.

### SUMMARY

One aspect of the present invention is to provide a transfer apparatus for transferring a toner image onto a sheet having: an endless belt; a plurality of rollers for supporting the endless belt around the plurality of rollers; and a discharge section for corona discharging the sheet, wherein the plurality of rollers includes a transfer roller for forming a transfer nip used to transfer the toner image onto the sheet and a separation roller for separating the sheet from the endless belt, and the transfer roller and the separation roller are straight shaped rollers each having a substantially uniform diameter along the longitudinal direction; and wherein at least one of the plurality of rollers other than the transfer roller and the separation roller is formed into a crown shape in which an axially central portion thereof is larger in outer diameter than both end portions thereof.

Another aspect of the present invention is to provide the transfer apparatus as described above, wherein the discharge section is provided at a position facing to the separation roller.

### BRIEF DESCRIPTION OF THE DRAWINGS

FIG. 1 is an overall cross sectional view representing the image forming apparatus equipped with an image forming apparatus main body A, automatic document feeder DF;

FIG. 2 is a cross sectional view showing around the transfer apparatus 5;

FIGS. 3(a) and (b) are diagrams representing the shape of the rollers of the transfer apparatus; wherein FIG. 3(a) is a front view representing the transfer roller 54 and separation roller 52; and FIG. 3(b) is a front view showing the driven rollers 53 (rollers other than transfer roller and separation roller);

FIG. 4 is an overall cross sectional view showing the image forming apparatus of another embodiment; and

FIG. 5 is a cross sectional view showing around the transfer apparatus 5b.

### DETAILED DESCRIPTION OF THE PREFERRED EMBODIMENTS

The following describes the embodiment of the present invention, without the present invention being restricted thereto.

### [Image Forming Apparatus]

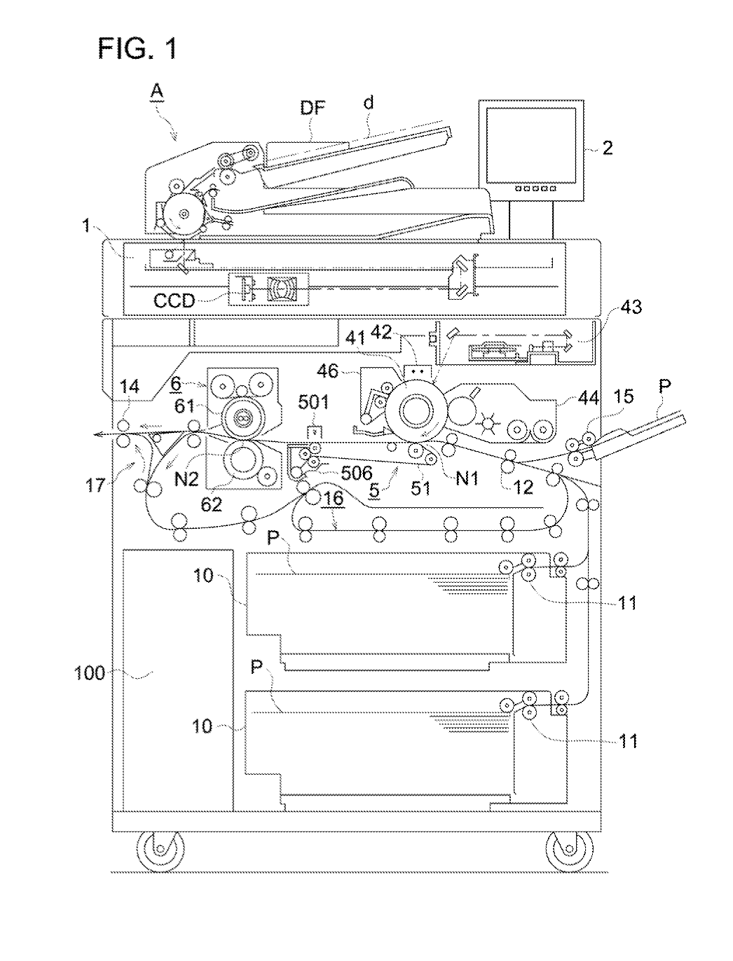

FIG. 1 is an overall cross sectional view representing the image forming apparatus equipped with an image forming apparatus main body A, automatic document feeder DF. In. FIG. 1, the image forming apparatus main body A includes an image reading apparatus 1, operation/display section 2, image forming section 4, transfer apparatus 5, fixing apparatus 6, and sheet conveyance system.

The image forming section 4 contains a photoreceptor 41, charging section 42, exposure section 43, developing device 44 and photoreceptor cleaning section 46.

The sheet conveyance system is made up of a sheet feeding cassette 10, first sheet feeding device 11, second sheet feeding device 12, sheet ejection device 14, manual sheet feeding device 15, circulating sheet re-feed device 16, and reversing/ejection device 17.

The document d placed on the document platen of the automatic document feeder DF is conveyed by the sheet feeding device. An image on one or both sides of the document d is read by the optional system of the image reading apparatus 1, and is read into the image sensor CCD. The analog signal subjected to photoelectric conversion by the image sensor CCD undergoes analog processing, analog-to-digital conversion, shading correction, image compression and the like in the image processing section (not illustrated). After that, image signal is sent to the exposure section 43.

In the image forming apparatus, the photoreceptor 41 is charged by the charging section 42 (negatively charged in the present embodiment). An electrostatic latent image is formed by the laser beam from the exposure section 43, and the electrostatic latent image is developed by the developing device 44, whereby a toner image (negatively charged in the present embodiment) is obtained. Then the sheet P stored in the sheet feeding cassette 10 is conveyed from the first sheet feeding device 11. The sheet P is synchronized with the toner image by the second sheet feeding device 12 made up of a registration roller, and the traveling position of the leading edge of the sheet P is detected by the detection sensor (not illustrated). The information is sent to the control device 100, whereby the time interval of entering the transfer nip section N1 formed between the transfer apparatus 5 and photoreceptor 41 is calculated. After that, the toner image is transferred onto the sheet P by the transfer nip section N1 that is formed by the transfer belt 51 of the transfer apparatus 5 and the photoreceptor 1, and the sheet P is conveyed by being statically adsorbed by the transfer belt 51. The sheet P conveyed onto the transfer belt 51 is electrically discharged through corona discharging by the separation/discharging electrode 500. At the same time, the sheet P is subjected to curvature-separation by the separation roller 52 and is conveyed to the fixing apparatus 6. The image is fixed onto the sheet P by the fixing nip section N2 formed of the fixing roller 61 of the fixing apparatus 6 and the pressure roller 62. After fixing, the sheet P is discharged out of the apparatus by the sheet ejection device 14. The transfer apparatus 5 of the invention of the present application will be described in details later.

In the meantime, the toner remaining on the photoreceptor 41 after transfer and the toner on the transfer belt 51 not yet transferred are removed by the photoreceptor cleaning section 46 and belt cleaning section SOS. In the case of duplex copying, the sheet P with an image formed on the first surface is fed into the circulating sheet re-feed device 16, and is switched back and reversed. After an image is again formed on the second surface in the image forming section 4, the sheet P is ejected out of the apparatus by the sheet ejection device 1. In the case of reversing and ejection, the sheet P having branched out of the normal ejection passage is switched back and reversed by the reversing/ejection device 17, and is then ejected out of the apparatus by the sheet ejection device 14.

### [Transfer Apparatus]

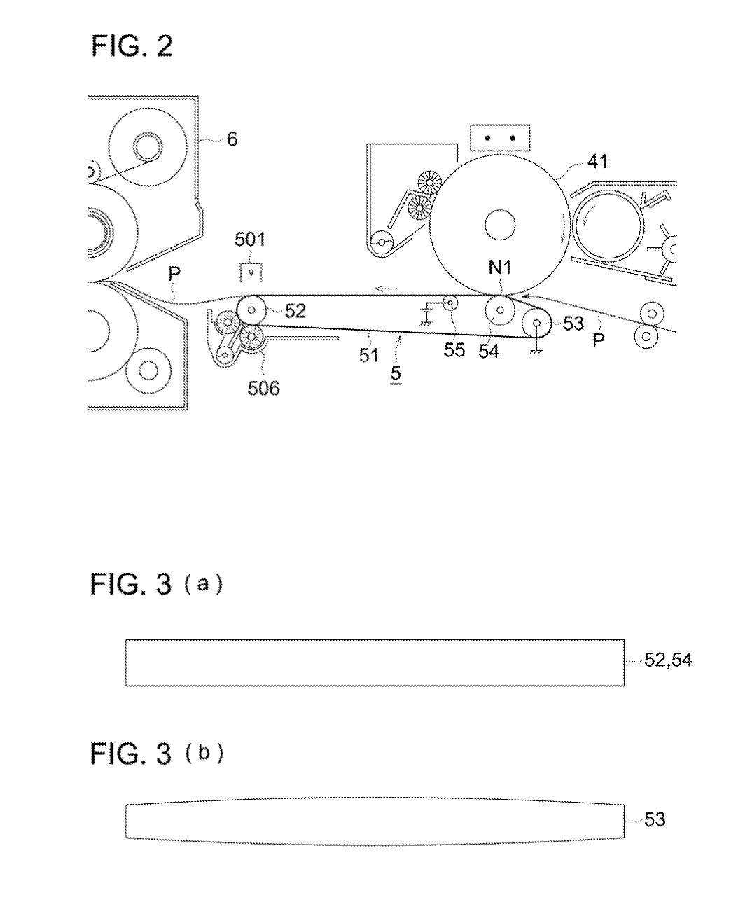

FIG. 2 is a cross sectional view showing around the transfer apparatus 5. In the transfer apparatus 5, a transfer belt S1 is supported by rollers such as a separation roller 52 of stainless steel (SUS), a driven roller 53 of aluminum alloy, a transfer roller 54 of foamed urethane, and a transfer bias roller 55 of stainless steel (SUS). The separation roller 52 serves as a drive roller, and is connected with a drive motor through a coupling gear (not illustrated), whereby the drive of the drive motor is transmitted to the transfer belt. The transfer belt is driven (moved) at a speed of 200 through 500 mm/sec, for example. The surface of the separation roller 52 is coated with rubber to increase friction coefficient.

In the present embodiment, what is called “transfer roller” is also referred to as a “back-up roller”. It is a roller which supports a transfer belt, and is used to form a transfer nip between the transfer roller and an image carrier such as the photoreceptor. The “separation roller” refers to the roller to which supports the transfer belt, and is a roller located around the separation position wherein the sheet having been adsorbed by the transfer belt is subjected to curvature separation or other separation.

The transfer belt is made of such a resin material as polyimide (PI), polyvinylidene fluoride (PVDF) and ethylene copolymer (ETFE) or such a rubber material as polyurethane rubber wherein a conductive filler of carbon or the like is dispersed to adjust resistance, or wherein an ionic conductive material is included.

The transfer voltage to form a transfer field having a polarity reverse to that of the toner is applied to the bias roller 55. The back-up roller 54 is formed of foamed urethane. A straight shaped roller is used as the bias roller 55. It is also possible to apply transfer voltage using a conductive brush instead of the bias roller 55.

The separation/discharging electrode 501 is a discharging electrode for corona discharging, and is provided at a position facing to the separation roller 52. The separation/discharging electrode 501 is a needle-shaped electrode (also known as the saw-toothed electrode), and the vertexes as the peak portions are arranged at a predetermined pitch over the entire region across the width of the traveling sheet at an interval of about 1 through 5 mm, for example, by etching a 0.1 mm thick SUS plate. The DC voltage having the polarity reverse to that of the bias roller or the voltage formed by superimposing the AC voltage to this DC voltage is applied to the needle-shaped electrode. It is also possible to utilize the separation/discharging electrode using a discharge wire of tungsten or the like, instead of the needle-shaped electrode.

FIG. 3 is a diagram representing the shape of the roller of the transfer apparatus. FIG. 3(a) is a front view representing the transfer roller 54 and separation roller 52, and FIG. 3(b) is a front view showing the driven rollers 53 (rollers other than transfer roller and separation roller);

As shown in FIG. 3(a), the transfer roller 54 and separation roller 52 has a straight shape wherein the diameter is substantially uniform in the longitudinal direction (axial direction).

Such a straight shaped roller ensures that the width of the transfer nip N1 formed by the transfer roller 54 and photoreceptor 41 can be made uniform in the axial direction. This arrangement provides uniform transfer in the axial direction. Further, the discharging performance for the separation roller 52 using the separation/discharging electrode 501 and the sheet P being conveyed can be made uniform in the axial direction, with the result that the problem resulting from excessive or insufficiency of discharging can be solved. The “problem resulting from excessive or insufficiency of discharging” in the sense in which it is used here refers to (1) the case wherein, since toner is reversely charged by partial excessive discharge, the toner once transferred onto the transfer material is re-deposited on the surface of the latent image carrier; and (2) the case wherein an image defect is caused by separation failure by partial insufficient discharge, or toner dispersion resulting from separation charge that occurs when the sheet P is separated from the transfer belt.

As shown in FIG. 3(b), the driven roller 53 has a crown shape in which a axially central portion thereof is larger in outer diameter than both end portions thereofs. The amount of crown is such that the diameter at the center is larger than the radius on ends by 100 μm through 2000 μm. The length of the driven roller 53 in the axial direction is about 310 mm through 370 mm.

Use of the aforementioned crown shaped roller avoids meandering which occurs when the transfer belt 51 is fed. It should be noted in passing that, in the description of the embodiment, reference has been made of an example of using a crown shaped roller as the rollers other than the transfer roller and separation roller. In this connection, it is also possible to use an inverted crown shaped roller as well as a crown shaped roller.

### Another Embodiment

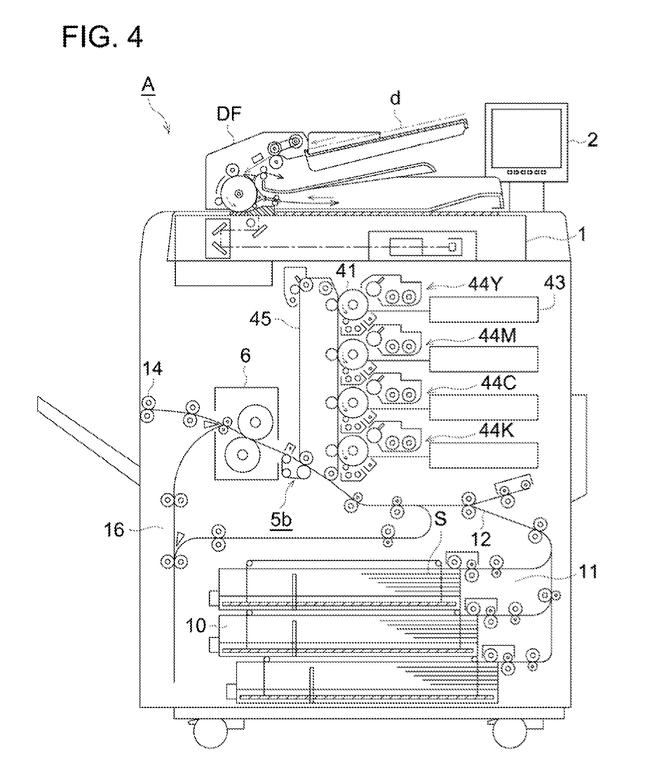

FIG. 4 is an overall cross sectional view showing the image forming apparatus of another embodiment. The members having the same function as those of FIG. 1 are assigned with, the same reference numbers, and will, not be described to avoid duplication. The image forming apparatus of FIG. 4 is a full color type image forming apparatus. The developing devices for different colors (44Y, 44M, 44C and 44K) each include a two-component developer made up of the toner particles of yellow (Y), magenta (M), cyan (C) and black (K) and carriers. The toner images of different colors formed by developing the photoreceptors 41 for different colors (reference symbols omitted for K, C and K) by the toners of different colors are transferred primarily onto the intermediate transfer apparatus 45 in the later step.

The color toner image obtained by superimposing the toner images of different colors by primarily transferring onto the intermediate transfer belt 451 of the intermediate transfer apparatus 45 is secondarily transferred onto the sheet P by the transfer apparatus (secondary transfer apparatus) 5b, The sheet P with the color toner image transferred thereon is conveyed to the fixing apparatus 6 wherein the image is fixed thereon. After fixing, the sheet P is ejected out of the apparatus by the sheet ejection device 14.

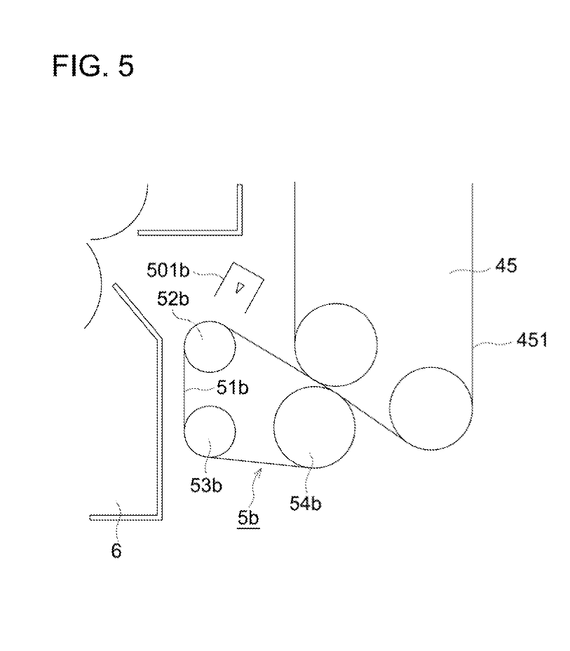

FIG. 5 is a cross sectional view showing around the transfer apparatus 5b. The transfer apparatus 5b includes a straight shaped transfer roller 54b, a separation roller 52b, a drive roller 53b as a crown shaped roller, a transfer belt 51b supported by these rollers, and a separation/discharging electrode 501b. In the transfer apparatus of FIG. 5, the transfer voltage for forming the transfer field having the polarity reverse to that of the toner is applied to the transfer roller 54. The amount of crown and the material of each member are equivalent to those of the transfer apparatus 5 shown in FIGS. 2 and 3.

Thus, in the secondary transfer apparatus as well, straight shaped rollers are used as the transfer roller and separation roller, and a crown shaped roller is used as the drive roller as another roller. This arrangement provides a transfer apparatus using a transfer belt capable of ensuring the transfer and separation performance as well as the traveling stability of the transfer belt.

The present invention provides a transfer apparatus and image forming apparatus that ensures the transfer and separation performance as well as the traveling stability of the transfer belt.

What is claimed is:

1. A transfer apparatus for transferring a toner image onto a sheet comprising:
an endless belt;
a plurality of rollers for supporting the endless belt around the plurality of rollers; and
a discharge section for corona discharging the sheet;
wherein the plurality of rollers includes a transfer roller for forming a transfer nip used to transfer the toner image onto the sheet and a separation roller for separating the sheet from the endless belt, and the transfer roller and the separation roller are straight shaped rollers each having a substantially uniform diameter along the longitudinal direction; and
wherein at least one of the plurality of rollers other than the transfer roller and the separation roller is formed into a crown shape in which an axially central portion thereof is larger in outer diameter than both end portions thereof.

2. The transfer apparatus of claim 1, wherein the discharge section is provided at a position facing to the separation roller.

3. An image forming apparatus for forming an image on a sheet including an image forming section for forming a toner image and a transfer apparatus, the transfer apparatus comprising:
an endless belt;
a plurality of rollers for supporting the endless belt around the plurality of rollers; and
a discharge section for corona discharging the sheet;
wherein the plurality of rollers includes a transfer roller for forming a transfer nip used to transfer the toner image onto the sheet and a separation roller for separating the sheet from the endless belt, and the transfer roller and the separation roller are straight shaped rollers each having a substantially uniform diameter along the longitudinal direction; and
wherein at least one of the plurality of rollers other than the transfer roller and the separation roller is formed into a crown shape in which an axially central portion thereof is larger in outer diameter than both end portions thereof.

4. The image forming apparatus of claim 3, wherein the discharge section is provided, at a position facing to the separation roller.
